(19) United States
(12) Patent Application Publication
(10) Pub. No.: US 2025/0366400 A1
(43) Pub. Date: Dec. 4, 2025

(54) NEAR-FIELD COMMUNICATION SYSTEM FOR AN AGRICULTURAL SYSTEM

(71) Applicant: CNH Industrial America LLC, New Holland, PA (US)

(72) Inventor: Steven Alexander Iseman, Akron, PA (US)

(21) Appl. No.: 19/216,975

(22) Filed: May 23, 2025

Related U.S. Application Data
(60) Provisional application No. 63/652,262, filed on May 28, 2024.

(51) Int. Cl. A01F 15/07; G06K 7/10; G06K 19/07

(52) U.S. Cl. CPC A01F 15/0715; G06K 7/10009; G06K 19/0723; A01F 2015/076

(57) ABSTRACT

A near-field communication (NFC) system for an agricultural harvester includes an NFC writer disposed within a baler of the agricultural harvester. The NFC writer is configured to write information to an NFC tag, and the NFC tag is configured to be coupled to a bale of agricultural product within the baler. The NFC system also includes a controller comprising a processor and a memory. The controller is communicatively coupled to the NFC writer, and the controller is configured to output the information to the NFC writer and to control the NFC writer to write the information to the NFC tag.

### CROSS-REFERENCE TO RELATED APPLICATION

This application claims priority from and the benefit of U.S. Provisional Application Ser. No. 63/652,262, entitled “NEAR-FIELD COMMUNICATION SYSTEM FOR AN AGRICULTURAL SYSTEM”, filed May 28, 2024, which is hereby incorporated by reference in its entirety.

### BACKGROUND

The present disclosure relates generally to a near-field communication system for an agricultural system.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a near-field communication (NFC) system for an agricultural harvester includes an NFC writer disposed within a baler of the agricultural harvester. The NFC writer is configured to write information to an NFC tag, and the NFC tag is configured to be coupled to a bale of agricultural product within the baler. The NFC system also includes a controller comprising a processor and a memory. The controller is communicatively coupled to the NFC writer, and the controller is configured to output the information to the NFC writer and to control the NFC writer to write the information to the NFC tag.

Furthermore, in certain embodiments, a near-field communication (NFC) system for an agricultural system includes an NFC tag coupled to or positioned proximate to a component of the agricultural system. The NFC tag is configured to store a reference to a location within a manual, the location within the manual is associated with the component, and the NFC tag is configured to output the reference to a handheld device to enable the handheld device to display the location within the manual to an operator.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having a baler;

FIG. 2 is a schematic diagram of an embodiment of a baler that may be employed within the agricultural system of FIG. 1;

FIG. 3 is a block diagram of an embodiment of a near-field communication (NFC) system that may be employed within the baler of FIG. 2;

FIG. 4 is a block diagram of another embodiment of an NFC system that may be employed within the baler of FIG. 2;

FIG. 5 is a block diagram of a further embodiment of an NFC system that may be employed within the baler of FIG. 2; and

FIG. 6 is a block diagram of an embodiment of an NFC system that may be employed within the agricultural system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

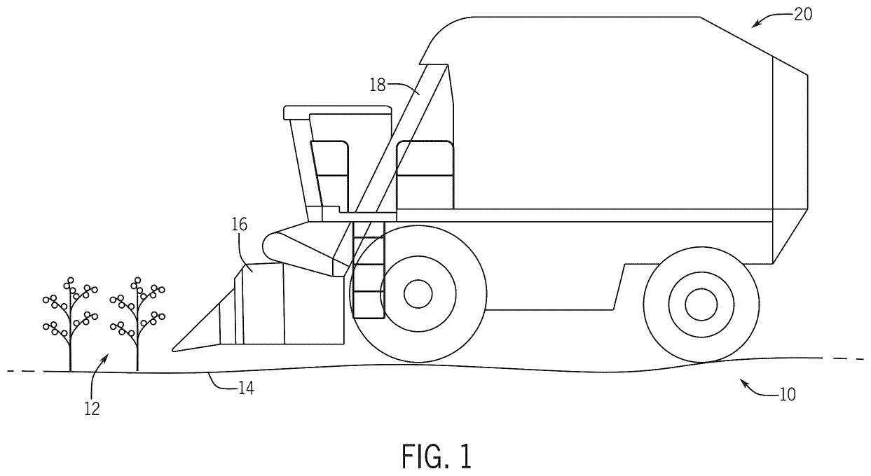

FIG. 1 is a side view of an embodiment of an agricultural system 10 (e.g., harvester) having a baler. The agricultural system 10 is configured to harvest agricultural product 12 (e.g., cotton) from a field 14 and to form the agricultural product 12 into bales (e.g., agricultural bales). For example, the agricultural system 10 includes a header 16 having drums configured to harvest the agricultural product 12 from the field 14. Additionally, the agricultural system 10 includes an air-assisted conveying system 18 configured to move the agricultural product 12 from the drums of the header 16 to an accumulator. The agricultural product 12 may then be fed into the baler 20 (e.g., agricultural baler), such as via belt(s). The baler 20 is supported by and/or mounted within or on a chassis of the agricultural system 10. As discussed in detail below, the baler 20 may form the agricultural product 12 into round bales. However, in other embodiments, the baler 20 of the agricultural system 10 may form the agricultural product into square bales, polygonal bales, or bales of other suitable shape(s). As described in greater detail below, after forming the agricultural product 12 into a bale, the bale wrapping system of the agricultural system 10 wraps the bale with a bale wrap to secure the agricultural product 12 within the bale and to generally maintain a shape of the bale.

In certain embodiments, the agricultural system 10 includes a near-field communication (NFC) system having an NFC writer and a controller. The NFC writer is disposed within the baler 20, and the NFC writer is configured to write information to an NFC tag. The NFC tag is configured to be coupled to a bale of the agricultural product 12 within the baler 20. Furthermore, the controller is communicatively coupled to the NFC writer, and the controller includes a processor and a memory. The controller is configured to output the information to the NFC writer and to control the NFC writer to write the information to the NFC tag.

The information stored on the NFC tag may facilitate subsequent processing of the bale. For example, the information may include a field location, a date and time of harvest, weather information, bale moisture at baling, a bale weight, planting information, baler operator information, fertilizer information, yield information, seed type, or a combination thereof. A handheld device may be used to read the information from the NFC tag, thereby enabling an operator to identify one or more properties of the bale, which may be useful for subsequent bale processing. Because the information is stored on the NFC tag, the information may be presented to the operator even when the handheld device is not connected to a network (e.g., as compared to a configuration in which the handheld device reads a code, such as a bar code or quick response (QR) code, on the bale and utilizes a network connection to access information associated with the code).

Furthermore, in certain embodiments, the NFC system includes an NFC tag coupled to or positioned proximate to a component of the agricultural system 10. The NFC tag is configured to store a reference to a location within a manual, in which the location within the manual is associated with the component. Furthermore, the NFC tag is configured to output the reference to a handheld device to enable the handheld device to display the location within the manual to an operator. Accordingly, an operator may use the handheld device to access information associated with a component by positioning the handheld device proximate to the NFC tag coupled to or positioned proximate to the component, thereby enhancing the efficiency of operating the agricultural system.

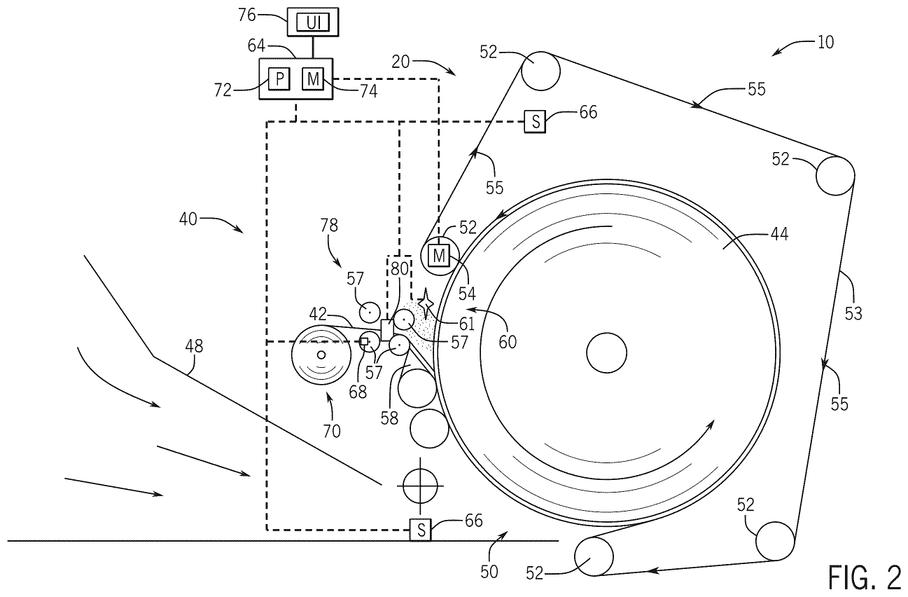

FIG. 2 is a schematic diagram of an embodiment of a baler 20 that may be employed within the agricultural system 10 of FIG. 1. The baler 20 is configured to form a bale 44 (e.g., a bale of the agricultural product, an agricultural bale, etc.), and a bale wrapping system 40 is configured to wrap a bale wrap 42 around the bale 44. As cotton or another agricultural product is harvested, the agricultural product flows into an accumulator 48. For example, the agricultural product may be blown by the air-assisted conveying system into the accumulator 48. The agricultural product is then fed into a cavity 50 of the baler 20 via a conveying system. The baler 20 includes multiple rollers 52 that support and/or drive rotation of one or more belts 53. For example, one or more rollers 52 engage the belt(s) 53, which enable the belt(s) 53 to move along the pathway defined by the rollers 52 and the bale 44. One or more rollers are driven to rotate via a belt drive system 54 (e.g., including electric motor(s), hydraulic motor(s), pneumatic motor(s), etc.). The belt(s) 53 circulate around the path defined by the rollers 52 and the bale 44, as indicated by arrows 55. Movement of the belt(s) 53 captures agricultural product from the accumulator 48 and draws the agricultural product into the cavity 50, where the agricultural product is gradually built up to form the bale 44. As the agricultural product builds within the cavity 50, one or more of the rollers 52 may move radially outwardly to accommodate the increasing size of the bale 44.

Once the bale 44 reaches a desired size, the bale wrapping system 40 of the baler 20 wraps the bale 44 with the bale wrap 42 to secure the agricultural product within the bale 44 and to generally maintain a shape of the bale 44, such as the round shape in the illustrated embodiment. In other embodiments, the shape of the bale may be rectangular, polygonal, or another suitable shape. The bale wrap 42 is fed into contact with the bale 44 with one or more feed rollers 57 and over a wrap guide or wrap applicator 58 (e.g., duckbill). The wrap guide/wrap applicator 58 is configured to move (e.g., rotate) to direct the bale wrap 42 into contact with the bale 44. The bale wrap 42 is captured between the bale 44 and the belt(s) 53. Accordingly, rotation of the bale 44 draws the bale wrap 42 around the bale 44, thereby wrapping the bale 44.

To secure the bale wrap 42 around the bale 44, the bale wrapping system 40 includes an adhesive system 60. In certain embodiments, the adhesive system 60 includes one or more sprayers 61 that spray an adhesive onto the bale wrap 42. The adhesive is configured to couple one section of the bale wrap 42 to another section of the bale wrap 42, thereby securing the bale wrap 42 around the bale 44.

In certain embodiments, after the bale wrap 42 is wrapped around the bale 44, the bale wrap 42 is cut with a cutting system to separate additional bale wrap 42 (e.g., on a shaft of a bale wrap assembly) from the bale wrap 42 surrounding the bale 44. The cutting system may include a cutting mechanism, an actuation assembly coupled to the cutting mechanism, and a track. The cutting mechanism may include a knife that engages the bale wrap 42 to cut the bale wrap 42. In other embodiments, the cutting mechanism may include other suitable mechanism(s) configured to cut the bale wrap (e.g., a rotary knife, a duckbill knife, a saw, a shear bar, etc.). In some embodiments, the actuation assembly is configured to move the cutting mechanism along a track to selectively drive the cutting mechanism into engagement with the bale wrap 42.

In the illustrated embodiment, the agricultural system 10 includes a controller 64. The controller 64 may be configured to control rotation of the belt(s) 53 and/or a belt speed of the belt(s) 53. In the illustrated embodiment, the controller 64 is communicatively coupled to the belt drive system 54, and the controller 64 is configured to control a rotation rate of one or more rollers 52 to control the belt speed of the belt(s) 53. The controller 64 may control the belt speed of the belt(s) 53 in response to feedback from one or more sensors 66. The sensor(s) 66 are communicatively coupled to the controller 64, and the sensor(s) 66 are configured to output sensor signal(s) indicative of a flow rate of the agricultural product, size of the bale 44, other suitable parameter(s), or a combination thereof.

In some embodiments, upon determining the bale 44 has reached a desired size (e.g., based on feedback from the sensor(s) 66), the controller 64 may automatically activate a bale wrapping process. For example, the controller 64 may receive signal(s) from the sensor(s) 66 indicative of the size of the bale 44 (e.g., weight, diameter, circumference, etc.). Upon determining the bale 44 has reached a target size, the controller 64 may activate the bale wrapping system 40 to initiate the bale wrapping process. For example, in the illustrated embodiment, the controller 64 is communicatively coupled to a bale wrap shaft drive system 68 (e.g., including electric motor(s), hydraulic motor(s), pneumatic motor(s), etc.), which is coupled to one or more feed rollers 57 and configured to drive the feed roller(s) 57 to rotate, thereby driving the bale wrap 42 to move toward the bale 44, which drives the shaft of the bale wrap assembly 70 to rotate. The bale wrap assembly 70 includes the shaft and the bale wrap 42 disposed about the shaft. The controller 64 may activate the bale wrap shaft drive system 68 to begin feeding the bale wrap 42 toward the bale 44. In some embodiments, the wrap guide 58 (e.g., duckbill) may be actuated (e.g., rotated), which drives the bale wrap 42 into contact with the bale 44. As previously discussed, the bale wrap 42 is captured between the bale 44 and the belt(s) 53. Accordingly, rotation of the belt(s) 53 draws the bale wrap 42 around the bale 44.

In certain embodiments, the controller 64 is configured to control the adhesive system 60 based on feedback from the sensor(s) 66. For example, the sensor(s) 66 may be configured to output sensor signal(s) indicative of an amount of bale wrap 42 that is wrapped around the bale 44. In response to determining that the amount of bale wrap 42 wrapped around the bale is approaching a target amount, the controller 64 may activate the adhesive system 60 to apply adhesive to the bale wrap 42.

In certain embodiments, the controller 64 is configured to control movement and operation of the cutting system. For example, the controller 64, which is communicatively coupled to the cutting system, may control engagement of a cutting mechanism of the cutting system with the bale wrap 42, such that the cutting mechanism cuts the bale wrap 42. For example, the controller 64 may activate the cutting mechanism in response to determining that the amount of bale wrap 42 wrapped around the bale 44 has reached the target amount. Once the bale wrap 42 is cut, the controller 64 controls the bale wrap shaft drive system 68 to terminate rotation of the shaft of the bale wrap assembly 70, and the controller controls the belt drive system 54 to continue rotation of the bale 44, such that the bale wrap 42 continues to rotate with the bale 44, thereby enabling the adhesive applied by the adhesive system 60 to secure the bale wrap 42 around the bale 44.

In certain embodiments, the controller 64 may control the adhesive system 60, the cutting system, the bale wrap shaft drive system 68, and the belt drive system 54 to control the bale wrapping process. For example, in response to the controller 64 determining that the bale 44 is in condition for wrapping, the controller 64 may control the belt drive system 54 to control the belt speed of the belt(s) 53, such that the belt(s) 53 reach a target belt speed for wrapping the bale 44. The target belt speed for wrapping the bale may be greater than or less than a target belt speed for bale formation. In certain embodiments, the belt speed may not be adjusted for wrapping the bale 44 (e.g., the target belt speed for wrapping the bale may be equal to the target belt speed for bale formation). The controller 64 may determine that the bale 44 is in condition for wrapping based on a weight of the bale 44 (e.g., based on feedback from the sensor(s) 66), a duration of the bale forming process, instructions from another controller (e.g., a harvester controller) to wrap the bale 44, based on a size of the bale 44 (e.g., based on feedback from the sensor(s) 66), other suitable parameter(s), or a combination thereof.

In response to determining the bale is in condition for wrapping, the controller 64 may control the bale wrap shaft drive system 68 to feed the bale wrap 42 toward the bale 44. The controller 64 may then output a signal to activate the adhesive system 60 in response to determining that the amount of bale wrap 42 wrapped around the bale 44 is approaching the target amount. Furthermore, in response to determining that the amount of bale wrap 42 wrapped around the bale 44 has reached the target amount, the controller 64 may output a signal to the cutting system to drive the cutting mechanism into engagement with the bale wrap 42, thereby cutting the bale wrap 42. Thereafter, the controller 64 may control the belt drive system 54 to stop rotation of the belt(s) 53. The wrapped bale 44 may then be ejected from the agricultural system 10 via a bale ejection system.

In the illustrated embodiment, the controller 64 includes a processor 72 and a memory 74. The processor 72 (e.g., a microprocessor) may be used to execute software, such as software stored in the memory 74, for controlling the bale wrapping process (e.g., controlling rotation of the bale 44, controlling the adhesive system 60, controlling the cutting system, etc.). Moreover, the processor 72 may include multiple microprocessors, one or more “general-purpose” microprocessors, one or more special-purpose microprocessors, and/or one or more application specific integrated circuits (ASICS), or some combination thereof. For example, the processor 72 may include one or more reduced instruction set (RISC) or complex instruction set (CISC) processors.

The memory 74 may include a volatile memory, such as random-access memory (RAM), and/or a nonvolatile memory, such as read-only memory (ROM). The memory 74 may store a variety of information and may be used for various purposes. For example, the memory 74 may store processor-executable instructions (e.g., firmware or software) for the processor 72 to execute, such as instructions for controlling the bale wrapping system 40. In certain embodiments, the controller 64 may also include one or more storage devices and/or other suitable components. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the bale wrapping system 40), and any other suitable data. The processor 72 and/or the memory 74, and/or an additional processor and/or memory device, may be located in any suitable portion of the agricultural system 10.

Additionally, the agricultural system 10 includes a user interface 76 communicatively coupled to the controller 64. The user interface 76 may be configured to provide information to an operator (e.g., indicative of the rotation rate of the bale 44, the belt speed of the belt(s) 53, an amount of the bale wrap 42 remaining in the bale wrap assembly 70, a size of the bale 44, an amount of adhesive remaining, other suitable parameter(s), or a combination thereof). Additionally, the user interface 76 may be configured to enable operator interactions with the bale wrapping system 40, such as control of the adhesive system 60, control of the cutting system, control of the belt speed of the belt(s) 53, control of other parameter(s), or a combination thereof. For example, the user interface 76 may include a display and/or other user interaction device(s) (e.g., button(s)) configured to enable operator interactions.

In the illustrated embodiment, the agricultural system 10 includes a near-field communication (NFC) system 78. As discussed in detail below, the NFC system 78 includes an NFC writer 80 disposed within the baler 20. The NFC writer 80 is configured to write information to an NFC tag, and the NFC tag is configured to be coupled to the bale 44 within the baler 20. In addition, the NFC writer 80 is communicatively coupled to the controller 64, and the controller 64 is configured to output the information to the NFC writer 80 and to control the NFC writer 80 to write the information to the NFC tag.

The information stored on the NFC tag may facilitate subsequent processing of the bale 44. For example, the information may include a field location, a date and time of harvest, weather information, bale moisture at baling, a bale weight, planting information, baler operator information, fertilizer information, yield information, seed type, or a combination thereof. A handheld device may be used to read the information from the NFC tag, thereby enabling the operator to identify one or more properties of the bale, which may be useful for subsequent bale processing. Because the information is stored on the NFC tag, the information may be presented to the operator even when the handheld device is not connected to a network (e.g., as compared to a configuration in which the handheld device reads a code, such as a bar code or quick response (QR) code, on the bale and utilizes a network connection to access information associated with the code).

Furthermore, in certain embodiments, the NFC system 78 includes an NFC tag coupled to or positioned proximate to a component of the agricultural system 10. The NFC tag is configured to store a reference to a location within a manual, in which the location within the manual is associated with the component. Furthermore, the NFC tag is configured to output the reference to a handheld device to enable the handheld device to display the location within the manual to an operator. Accordingly, an operator may use the handheld device to access information associated with a component by positioning the handheld device proximate to the NFC tag coupled to or positioned proximate to the component, thereby enhancing the efficiency of operating the agricultural system.

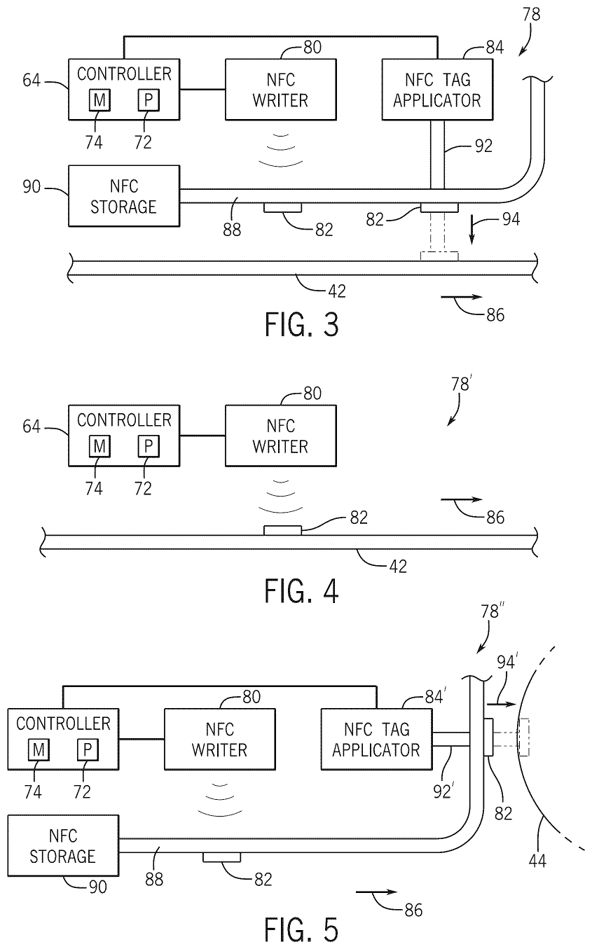

FIG. 3 is a block diagram of an embodiment of a near-field communication (NFC) system 78 that may be employed within the baler of FIG. 2. As previously discussed, the NFC writer 80 of the NFC system 78 is disposed within the baler of the agricultural system, and the NFC writer 80 is configured to write information to an NFC tag 82. In addition, the NFC tag 82 is configured to be coupled to a bale of agricultural product within the baler. As illustrated, the controller 64 is communicatively coupled to the NFC writer 80, and the controller 64 is configured to output the information to the NFC writer 80 and to control the NFC writer 80 to write the information to the NFC tag 82. In the illustrated embodiment, the controller 64 of the NFC system 78 corresponds to the controller of the agricultural system disclosed above with reference to FIG. 2. However, in other embodiments, the NFC system may include a controller separate from the controller of the agricultural system. In such embodiments, the NFC system controller includes a processor and a memory, and the controller is configured to perform the functions disclosed herein.

The NFC writer 80 includes a wireless transmitter configured to wirelessly transmit the information to each NFC tag 82. In addition, each NFC tag 82 includes a wireless transceiver and a storage device. The wireless transceiver is configured to receive the information from the NFC writer 80, and the storage device is configured to store the information. The wireless transceiver is also configured to wirelessly transmit the information to a wireless receiver of a handheld device (e.g., automatically in response to the handheld device being positioned proximate to the NFC tag). Accordingly, the handheld device may be used to read the information from the NFC tag, thereby enabling an operator to identify one or more properties of the bale, which may be useful for subsequent bale processing. Because the information is stored on the NFC tag, the information may be presented to the operator even when the handheld device is not connected to a network (e.g., as compared to a configuration in which the handheld device reads a code, such as a bar code or quick response (QR) code, on the bale and utilizes a network connection to access information associated with the code).

In certain embodiments, the NFC writer 80 is configured to output a radio frequency (RF) field configured to power the NFC tag 82. For example, the wireless transmitter of the NFC writer 80 may output the RF field to power the NFC tag 82 and to wirelessly transmit the information to the NFC tag 82. In addition, the wireless receiver of the handheld device may also output an RF field configured to power the NFC tag 82. Because the NFC tag 82 is powered by the NFC writer 80 (e.g., while the NFC writer is writing the information to the NFC tag 82) and by the handheld device (e.g., while the handheld device is reading the information from the NFC tag 82), the NFC tag may not include a power source. However, in other embodiments, the NFC tag may include a power source (e.g., battery, etc.) configured to power the NFC tag (e.g., while the NFC writer is writing the information to the NFC tag and while the handheld device is reading the information from the NFC tag).

In the illustrated embodiment, the NFC system 78 includes an NFC tag applicator 84 configured to apply the NFC tag to the bale wrap 42, which is configured to surround the bale. In the illustrated embodiment, the NFC tag applicator 84 is positioned downstream from the NFC writer 80 with respect to a direction of movement 86 of the bale wrap 42 from the bale wrap assembly to the bale. Accordingly, the NFC tag applicator 84 is configured to receive the NFC tag 82 from the NFC writer 80 after the NFC writer has written the information to the NFC tag 82. However, in other embodiments, the NFC tag applicator may be positioned upstream of the NFC writer with respect to the direction of movement of the bale wrap, and the NFC writer may write the information to the NFC tag after the NFC tag applicator has applied the NFC tag to the bale wrap.

In the illustrated embodiment, multiple NFC tags 82 are coupled to a transfer sheet 88, and the transfer sheet 88 and the NFC tags 82 are stored within an NFC storage area 90. A feeding mechanism may drive the transfer sheet 88 to move along the direction of movement 86 from the NFC storage area 90, past the NFC writer 80, and past the NFC tag applicator 84, thereby enabling the NFC writer 80 to write the information to each NFC tag 82 and enabling the NFC tag applicator 84 to apply each NFC tag 82 to the bale wrap 42. In certain embodiments, the NFC tag applicator 84 includes a plunger 92 configured to extend along an extension direction 94 to separate each NFC tag 82 from the transfer sheet 88 and to drive the NFC tag 82 into engagement with the bale wrap 42. While the NFC tag applicator 84 includes the plunger 92 in the illustrated embodiment, in other embodiments, the NFC tag applicator may include any other suitable mechanism(s) configured to drive the NFC tag into engagement with the bale wrap, such as a pivoting arm, a scissor mechanism, etc. Furthermore, while the NFC tags 82 are stored on the transfer sheet 88 in the illustrated embodiment, in other embodiments, the NFC tags may be stored in or on any other suitable device, such as a hopper, a bin, a tray, etc.

In certain embodiments, each NFC tag 82 includes an adhesive configured to couple a body of the NFC tag 82 to the bale wrap 42. Accordingly, the NFC tag 82 couples to the bale wrap 42 upon engagement with the bale wrap 42. In certain embodiments, the NFC tag applicator may activate the adhesive before the NFC tag engages the bale wrap. For example, the NFC tag applicator may remove a protective cover to expose the adhesive (e.g., via a brush, via application of heat, etc.). Furthermore, the NFC tag applicator may apply (e.g., spray, etc.) a chemical activator onto the adhesive to activate the adhesive. In addition, in certain embodiments, the NFC tag may not include an adhesive, and the NFC tag applicator may apply (e.g., spray, etc.) adhesive onto the NFC tag before driving the NFC tag into engagement with the bale wrap. While coupling the NFC tag to the bale wrap with an adhesive connection is disclosed above, in certain embodiments, the NFC tag may be coupled to the bale wrap with other suitable type(s) of connection(s) (e.g., alone or in combination with the adhesive connection), such as a sewed connection, a fastener connection, other suitable type(s) of connection(s), or a combination thereof.

In certain embodiments, the bale wrap 42 is wrapped around the bale multiple times to form multiple wraps around the bale. The NFC tag 82 may be applied to any suitable wrap of the bale wrap. For example, in certain embodiments, the NFC tag applicator may apply the NFC tag to the bale wrap, such that the NFC tag is coupled to the outer wrap of the bale wrap while the bale wrap is wrapped around the bale (e.g., an inner surface of the outer wrap or an outer surface of the outer wrap). Furthermore, in certain embodiments, the NFC tag applicator may apply the NFC tag to the bale wrap at a location that becomes an inner wrap of the bale wrap, such that the NFC tag is positioned between the inner wrap and the outer wrap of the bale wrap. In embodiments in which the NFC tag is positioned radially inward from the outer surface of the bale wrap while the bale wrap surrounds the bale, the bale wrap may block moisture, dirt, and debris from engaging the NFC tag, which may enhance the longevity of the NFC tag.

In certain embodiments, the NFC system 78 couples one NFC tag 82 to each bale. Accordingly, the controller 64 may control the feeding mechanism for the transfer sheet 88, the NFC writer 80, and the NFC tag applicator 84 to couple one NFC tag 82 to the bale wrap 42 for each bale. However, in other embodiments, the NFC system may couple multiple NFC tags to each bale. In such embodiments, the controller may control the feeding mechanism for the transfer sheet, the NFC writer, and the NFC tag applicator to couple multiple NFC tags to the bale wrap for each bale. The NFC tags may be spaced apart from one another along the bale wrap, such that the NFC tags are located at different circumferential positions around the wrapped bale. Furthermore, in certain embodiments, the NFC system may include multiple NFC tag applicators (e.g., to apply multiple NFC tags to the bale wrap for each bale concurrently). Because multiple NFC tags are coupled to the bale, if the wrapped bale is stored with the outer circumferential surface of the wrapped bale engaged with a surface (e.g., the ground), at least one NFC tag may be accessible to the handheld device. In embodiments in which multiple NFC tags are coupled to the bale, the NFC writer may write the same information to each NFC tag.

The information stored on the NFC tag 82 may facilitate subsequent processing of the bale. For example, the information may include a field location (e.g., determined by the controller via feedback from a spatial locating device, such as a global positioning system receiver, when the wrapped bale is deposited onto the field), a date and time of harvest, weather information (e.g., determined by the controller based on sensor feedback, received from an external source, etc.), bale moisture at baling (e.g., determined by the controller based on sensor feedback), a bale weight (e.g., determined by the controller based on sensor feedback), planting information (e.g., planting date/time, fertilizer application date/time, etc.), baler operator information (e.g., name, employee number, experience, etc.), fertilizer information, yield information (e.g., determined by the controller based on feedback from a yield monitor), seed type, other suitable information, or a combination thereof. The handheld device may be used to read the information from the NFC tag, thereby enabling the operator to identify one or more properties of the bale, which may be useful for subsequent bale processing. Because the information is stored on the NFC tag, the information may be presented to the operator even when the handheld device is not connected to a network (e.g., as compared to a configuration in which the handheld device reads a code, such as a bar code or quick response (QR) code, on the bale and utilizes a network connection to access information associated with the code).

In addition, in certain embodiments, the information stored on the NFC tag 82 may include a identification code (e.g., unique to each wrapped bale). The identification code may facilitate identification and tracking of the wrapped bale. For example, the identification code may enable an automated system to identify the wrapped bale while the wrapped bale is in the field and while the wrapped bale is being transported, thereby facilitating tracking of the wrapped bale.

FIG. 4 is a block diagram of another embodiment of an NFC system 78′ that may be employed within the baler of FIG. 2. In the illustrated embodiment, each NFC tag 82 is coupled to the bale wrap 42 before the bale wrap assembly is loaded into the bale wrapping system (e.g., during manufacture of the bale wrap assembly). In certain embodiments, the NFC tags 82 are spaced apart from one another along the direction of movement 86, such that only one NFC tag 82 is coupled to each bale. However, in other embodiments, the NFC tags 82 may be spaced apart from one another along the direction of movement 86, such that multiple NFC tags 82 are coupled to each bale. In such embodiments, the NFC tags may be spaced apart from one another along the bale wrap, such that the NFC tags are located at different circumferential positions around the wrapped bale. Accordingly, if the wrapped bale is stored with the outer circumferential surface of the wrapped bale engaged with a surface (e.g., the ground), at least one NFC tag may be accessible to the handheld device. In embodiments in which multiple NFC tags are coupled to the bale, the NFC writer may write the same information to each NFC tag.

FIG. 5 is a block diagram of a further embodiment of an NFC system 78″ that may be employed within the baler of FIG. 2. In the illustrated embodiment, the NFC system 78″ is configured to couple one or more NFC tags 82 to the agricultural product of the bale 44 (e.g., before the bale 44 is wrapped with the bale wrap). The NFC tag applicator 84′ is configured to dispose the NFC tag(s) 82 within the agricultural product of the bale 44, thereby coupling the NFC tag(s) 82 to the bale 44 (e.g., due to friction between the NFC tag(s) and the agricultural product). After the bale 44 is wrapped with the bale wrap, the NFC tag is positioned inside the bale wrap. Accordingly, the bale wrap may block moisture, dirt, and debris from engaging the NFC tag(s), which may enhance the longevity of the NFC tag(s). In the illustrated embodiment, the NFC tag applicator 84′ is positioned downstream from the NFC writer 80 with respect to the direction of movement 86. Accordingly, the NFC tag applicator 84′ is configured to receive each NFC tag 82 from the NFC writer 80 after the NFC writer has written the information to the NFC tag 82.

In the illustrated embodiment, multiple NFC tags 82 are coupled to a transfer sheet 88, and the transfer sheet 88 and the NFC tags 82 are stored within an NFC storage area 90. A feeding mechanism may drive the transfer sheet 88 to move along the direction of movement 86 from the NFC storage area 90, past the NFC writer 80, and past the NFC tag applicator 84′, thereby enabling the NFC writer 80 to write the information to each NFC tag 82 and enabling the NFC tag applicator 84′ to couple each NFC tag 82 to the bale 44. In certain embodiments, the NFC tag applicator 84′ includes a plunger 92′ configured to extend along an extension direction 94′ to separate the NFC tag 82 from the transfer sheet 88 and to drive the NFC tag 82 into engagement with the bale 44. While the NFC tag applicator 84′ includes the plunger 92′ in the illustrated embodiment, in other embodiments, the NFC tag applicator may include any other suitable mechanism(s) configured to drive the NFC tag into engagement with the bale, such as a pivoting arm, a scissor mechanism, etc. Furthermore, while the NFC tags 82 are stored on the transfer sheet 88 in the illustrated embodiment, in other embodiments, the NFC tags may be stored in or on any other suitable device, such as a hopper, a bin, a tray, etc.

In certain embodiments, the NFC system 78″ couples one NFC tag 82 to each bale 44. Accordingly, the controller 64 may control the feeding mechanism for the transfer sheet 88, the NFC writer 80, and the NFC tag applicator 84′ to couple one NFC tag 82 to each bale. However, in other embodiments, the NFC system may couple multiple NFC tags to each bale. In such embodiments, the controller may control the feeding mechanism for the transfer sheet, the NFC writer, and the NFC tag applicator to couple multiple NFC tags to the bale. The NFC tags may be coupled to the bale at different circumferential positions (e.g., by rotating the bale during the NFC tag application process). Furthermore, in certain embodiments, the NFC system may include multiple NFC tag applicators (e.g., to couple multiple NFC tags to the bale concurrently). Because multiple NFC tags are coupled to the bale, if the wrapped bale is stored with the outer circumferential surface of the wrapped bale engaged with a surface (e.g., the ground), at least one NFC tag may be accessible to the handheld device. In embodiments in which multiple NFC tags are coupled to the bale, the NFC writer may write the same information to each NFC tag.

The embodiments of the NFC system disclosed above with reference to FIGS. 3-5 may not include an NFC reader configured to read the information from the NFC tag. Accordingly, the cost and complexity of the NFC system may be reduced. However, in certain embodiments, the NFC system may include an NFC reader configured to read the NFC tag after the NFC writer writes the information to the NFC tag (e.g., to verify the accuracy of the information, to verify effective operation of the NFC tag, etc.). Furthermore, the embodiments of the NFC system disclosed above with reference to FIGS. 3-5 are configured to position the NFC tag(s) along a circumference of the bale (e.g., on the bale wrap or within the agricultural product of the bale). However, in certain embodiments, the NFC system (e.g., any of the NFC systems disclosed above with reference to FIGS. 3-5) may be configured to apply one or more NFC tags to at least one longitudinal end of the bale (e.g., on the bale wrap or within the agricultural product of the bale). In such embodiments, the NFC tag(s) may be accessible to the handheld device if the wrapped bale is stored with the outer circumferential surface of the wrapped bale engaged with a surface (e.g., the ground). In addition, in certain embodiments, the NFC system (e.g., any of the NFC systems disclosed above with reference to FIGS. 3-5) may be configured to apply one or more NFC tags to at least one longitudinal end of the bale and to apply one or more NFC tags along the circumference of the bale.

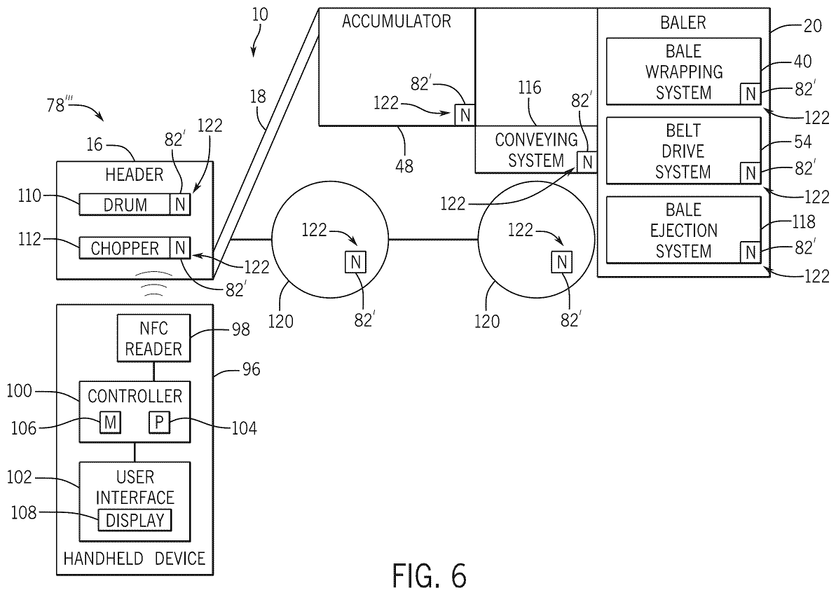

FIG. 6 is a block diagram of an embodiment of an NFC system 78′″ that may be employed within the agricultural system of FIG. 1. In the illustrated embodiment, the NFC system 78′″ includes an NFC tag 82′ coupled to a component of the agricultural system 10. The NFC tag 82′ is configured to store a reference to a location within a manual, in which the location within the manual is associated with the component. In addition, the NFC tag 82′ is configured to output the reference to a handheld device 96 to enable the handheld device 96 to display the location within the manual to an operator. Accordingly, an operator may use the handheld device 96 to access information associated with a component by positioning the handheld device proximate to the NFC tag 82′ coupled to the component, thereby enhancing the efficiency of operating the agricultural system 10 (e.g., as compared to manually searching through the manual to locate information associated with the component).

In the illustrated embodiment, the handheld device 96 includes an NFC reader 98, a controller 100, and a user interface 102. The handheld device 96 may be any suitable type of handheld device, such as a phone, a tablet, a portable computer, etc. The NFC reader 98 and the user interface 102 are communicatively coupled to the controller 100. The NFC reader 98 is configured to read information (e.g., the reference to the location within the manual) from each NFC tag 82′ and to output the information to the controller 100. In addition, the controller 100 is configured to receive the information (e.g., the reference to the location within the manual) from the NFC reader 98 and to control the user interface 102 based on the information.

In certain embodiments, the controller 100 is an electronic controller having electrical circuitry configured to control the user interface 102. In the illustrated embodiment, the controller 100 includes a processor 104, such as a microprocessor, and a memory device 106. The controller 100 may also include one or more storage devices and/or other suitable components. The processor 104 may be used to execute software, such as software for controlling the user interface 102, and so forth. Moreover, the processor 104 may include multiple microprocessors, one or more “general-purpose” microprocessors, one or more special-purpose microprocessors, and/or one or more application specific integrated circuits (ASICs), or some combination thereof. For example, the processor 104 may include one or more reduced instruction set (RISC) processors.

The memory device 106 may include a volatile memory, such as random access memory (RAM), and/or a nonvolatile memory, such as read-only memory (ROM). The memory device 106 may store a variety of information and may be used for various purposes. For example, the memory device 106 may store processor-executable instructions (e.g., firmware or software) for the processor 104 to execute, such as instructions for controlling the user interface 102, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the user interface 102, etc.), and any other suitable data.

Furthermore, the user interface 102 is configured to receive input from an operator and to provide information to the operator. The user interface 102 may include any suitable input device(s) for receiving input, such as a keyboard, a mouse, button(s), switch(es), knob(s), other suitable input device(s), or a combination thereof. In addition, the user interface 102 may include any suitable output device(s) for presenting information to the operator, such as speaker(s), indicator light(s), other suitable output device(s), or a combination thereof. In the illustrated embodiment, the user interface 102 includes a display 108 configured to present visual information to the operator. In certain embodiments, the display 108 may include a touchscreen interface configured to receive input from the operator.

The NFC reader 98 of the handheld device 96 includes a wireless receiver configured to wirelessly receive information (e.g., the reference to the location within the manual) from each NFC tag 82′. As previously discussed with regard to the NFC tags disclosed above with reference to FIGS. 3-5, each NFC tag 82′ includes a wireless transceiver and a storage device. The wireless transceiver of the NFC tag 82′ is configured to receive information (e.g., the reference to the location within the manual) from an NFC writer, and the storage device is configured to store the information. The wireless transceiver is also configured to wirelessly transmit the information to the wireless receiver of the NFC reader 98 of the handheld device 96 (e.g., automatically in response to the handheld device 96 being positioned proximate to the NFC tag 82′). Accordingly, the handheld device 96 may be used to read the information from the NFC tag 82′.

In certain embodiments, the NFC reader 98 of the handheld device 96 is configured to output a radio frequency (RF) field configured to power the NFC tag 82′. For example, the wireless receiver of the NFC reader 98 may output the RF field to power the NFC tag 82′ and to wirelessly receive the information from the NFC tag 82′. Because the NFC tag 82′ is powered by the NFC reader 98 (e.g., while the NFC reader is reading the information from the NFC tag 82′), the NFC tag 82′ may not include a power source. However, in other embodiments, the NFC tag may include a power source (e.g., battery, etc.) configured to power the NFC tag (e.g., while the NFC reader of the handheld device is reading the information from the NFC tag).

In the illustrated embodiment, the NFC system 78′″ includes an NFC tag 82′ coupled to a drum 110 of the header 16, an NFC tag 82′ coupled to a chopper 112 of the header 16, an NFC tag 82′ coupled to the accumulator 48, an NFC tag 82′ coupled to the conveying system 116, an NFC tag 82′ coupled to the bale wrapping system 40, an NFC tag 82′ coupled to the belt drive system 54, an NFC tag 82′ coupled to the bale ejection system 118, and an NFC tag 82′ coupled to each wheel 120 of the agricultural system 10. However, in other embodiments, the NFC system may include fewer NFC tags coupled to a portion of the components disclosed above. Furthermore, in certain embodiments, the NFC system may include one or more NFC tags coupled to one or more additional components of the agricultural system (e.g., component(s) within an interior of a cabin, engine component(s), etc.). While the NFC tags of the NFC system are coupled to component(s) of an agricultural harvester in the illustrated embodiment, in other embodiments, NFC tag(s) of the NFC system may be coupled to component(s) of another suitable type of agricultural system, such as a tillage implement, a sprayer, a planter, a seeder, a tractor, a skid steer, a bulldozer, etc.

In the illustrated embodiment, each NFC tag 82′ includes an adhesive 122 configured to couple a body of the NFC tag 82 to the component. Accordingly, each NFC tag 82′ is coupled to the respective component by an adhesive connection. However, in certain embodiments, at least one NFC tag may be coupled to the respective component with other suitable type(s) of connection(s) (e.g., alone or in combination with the adhesive connection), such as a fastener connection, an ultrasonically welded connection, other suitable type(s) of connection(s), or a combination thereof. To facilitate access to each NFC tag 82′, the NFC tag 82′ may be coupled to a non-moving portion of the component, and/or the NFC tag 82′ may be coupled to a portion of the component that is readily accessible by the operator.

By way of example, if the operator is interested in information (e.g., maintenance procedures, operating procedures, operating parameters, etc.) for a component (e.g., the drum 110, the chopper 112, the accumulator 48, the conveying system 116, the bale wrapping system 40, the belt drive system 54, the bale ejection system 118, a wheel 120, etc.), the operator may approach the component with the handheld device 96. The operator may then position the handheld device 96 proximate to the NFC tag 82′ coupled to the component. The NFC tag 82′ coupled to the component stores a reference to a location within a manual, in which the location within the manual is associated with the component. In response to positioning the handheld device 96 proximate to the NFC tag 82′, the NFC tag 82′ outputs the reference to the location within the manual to the NFC reader 98 of the handheld device 96. The controller 100 of the handheld device 96 receives the reference to the location and controls the display 108 to present the location within the manual to the operator.

While each NFC tag 82′ is coupled to a component in the illustrated embodiment, in other embodiments, at least one NFC tag 82′ may be positioned proximate to the component. For example, in certain embodiments, the NFC tag 82′ may be coupled to a structure proximate to the component (e.g., by the adhesive 122). As used herein with regard to positioning an NFC tag proximate to the component, “proximate” refers to a location that is within a threshold distance of the component. For example, the threshold distance may be 100 cm, 50 cm, 25 cm, 20 cm, 15 cm, 10 cm, or 5 cm. By way of further example, the threshold distance may be less than or equal to 100 cm, 50 cm, 25 cm, 20 cm, 15 cm, 10 cm, or 5 cm. Positioning the NFC tag within the threshold distance of the component may enable an operator to associate the NFC tag with the component (e.g., as compared to another component). Furthermore, in certain embodiments, the NFC tag may be labeled with the name of the component to facilitate identification of the NFC tag.

In certain embodiments, the entirety of the manual is stored within the controller 100, and the controller 100 controls the display 108 to present the location within the reference in response to receiving the reference from the NFC reader 98. Because the manual is stored within the controller of the handheld device, the location within the manual may be presented to the operator even when the handheld device is not connected to a network. In addition, because the handheld device receives the reference from the NFC tag, the controller of the handheld device may control the display to present the location within the manual without a network connection (e.g., as compared to receiving information from a QR code and using a network connection to retrieve the reference based on the information). However, in certain embodiments, the handheld device may be connected to a network. In such embodiments, the handheld device may access the manual via the network.

Furthermore, in certain embodiments, the reference includes a page number or a chapter number within the manual. However, in other embodiments, the reference may include another suitable property of the manual, such as a volume number, a name of the manual (e.g., in embodiments in which multiple manuals are associated with an agricultural system), or another suitable property. In addition, in certain embodiments, the reference may include multiple properties, such as a name of the manual, a volume number within the manual, a chapter number within the volume, a page number within the chapter, or any combination thereof. Furthermore, in certain embodiments, the reference may include a key word or a part number, which may correspond to multiple locations within the manual. For example, the key word may be a reference to each location within the manual that uses the key word, and the part number may be a reference to each location within the manual that references the part number.

In certain embodiments, a portion of the manual associated with the component may be stored on the NFC tag (e.g., alone or in combination with the reference to the location within the manual). In such embodiments, in response to positioning the handheld device proximate to the NFC tag, the NFC tag outputs the portion of the manual to the NFC reader of the handheld device. The controller of the handheld device receives the portion of the manual and controls the display to present the portion of the manual to the operator. As a result, the operator may view the portion of the manual even though the manual is not stored within the controller of the handheld device, and the handheld device is not connected to a network. Furthermore, in certain embodiments, the agricultural system 10 may include the NFC system 78′″ disclosed above with reference to FIG. 6, an NFC system disclosed above with reference to FIGS. 3-5, or a combination thereof.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A near-field communication (NFC) system for an agricultural harvester, comprising:
an NFC writer disposed within a baler of the agricultural harvester, wherein the NFC writer is configured to write information to an NFC tag, and the NFC tag is configured to be coupled to a bale of agricultural product within the baler; and
a controller comprising a processor and a memory, wherein the controller is communicatively coupled to the NFC writer, and the controller is configured to output the information to the NFC writer and to control the NFC writer to write the information to the NFC tag.

2. The NFC system of claim 1, wherein the NFC writer is configured to output a radio frequency field configured to power the NFC tag.

3. The NFC system of claim 1, wherein the information comprises a field location, a date and time of harvest, weather information, bale moisture at baling, a bale weight, planting information, baler operator information, fertilizer information, yield information, seed type, or a combination thereof.

4. The NFC system of claim 1, comprising an NFC tag applicator configured to apply the NFC tag to the bale or to a bale wrap configured to surround the bale.

5. The NFC system of claim 4, wherein the NFC tag applicator is configured to apply the NFC tag to the bale wrap at a location that enables the NFC tag to be positioned radially inward from an outer surface of the bale wrap.

6. The NFC system of claim 4, wherein the NFC tag applicator is configured to receive the NFC tag from the NFC writer after the NFC writer has written the information to the NFC tag.

7. The NFC system of claim 1, wherein the NFC system does not comprise an NFC reader configured to read the information from the NFC tag.

8. The NFC system of claim 1, comprising the NFC tag, wherein the NFC tag is coupled to a bale wrap configured to surround the bale.

9. A method for associating information with a bale of agricultural product, comprising:
outputting, via a controller comprising a memory and a processor, the information to a near-field communication (NFC) writer disposed within a baler of an agricultural harvester; and
writing, via the NFC writer communicatively coupled to the controller, the information to an NFC tag configured to couple to the bale.

10. The method of claim 9, comprising outputting, via the NFC writer, a radio frequency field configured to power the NFC tag.

11. The method of claim 9, wherein the information comprises a field location, a date and time of harvest, weather information, bale moisture at baling, a bale weight, planting information, baler operator information, fertilizer information, yield information, seed type, or a combination thereof.

12. The method of claim 9, comprising applying, via an NFC tag applicator, the NFC tag to the bale or to a bale wrap configured to surround the bale.

13. The method of claim 12, comprising applying, via the NFC tag applicator, the NFC tag to the bale wrap at a location that enables the NFC tag to be positioned radially inward from an outer surface of the bale wrap.

14. The method of claim 12, receiving the NFC tag, at the NFC tag applicator, after the NFC writer has written the information to the NFC tag.

15. The method of claim 9, comprising coupling the NFC tag to a bale wrap before the bale wrap is wrapped around the bale.

16. A near-field communication (NFC) system for an agricultural system, comprising:
an NFC tag coupled to or positioned proximate to a component of the agricultural system, wherein the NFC tag is configured to store a reference to a location within a manual, the location within the manual is associated with the component, and the NFC tag is configured to output the reference to a handheld device to enable the handheld device to display the location within the manual to an operator.

17. The NFC system of claim 16, wherein the NFC tag is configured to be powered by a radio frequency field output by the handheld device.

18. The NFC system of claim 16, wherein the reference comprises a page number within the manual or a chapter number within the manual.

19. The NFC system of claim 16, wherein the component comprises a chopper, an accumulator, a drum, or a wheel.

20. The NFC system of claim 16, wherein the NFC tag comprises an adhesive configured to couple a body of the NFC tag to the component or to a structure proximate to the component.
